(19) United States
(12) Patent Application Publication
(10) Pub. No.: US 2007/0061452 A1
(43) Pub. Date: Mar. 15, 2007

(54) Market data notification system

(75) Inventors: Bernard A. Weinstein, Pound Ridge, NY (US); Steven Bongiovanni, Howard Beach, NY (US); Kevin J. Flynn, New York, NY (US)

Correspondence Address: COVINGTON & BURLING, LLP;ATTN: PATENT DOCKETING, 1201 PENNSYLVANIA AVENUE, N.W., WASHINGTON, DC, 20004-2401, US

(73) Assignee: The Thomson Corporation, Stamford, CT (US)

(21) Appl. No.: 11/595,901

(22) Filed: Nov. 13, 2006

Related U.S. Application Data
(63) Continuation of application No. 08/863,037, filed on May 23, 1997.

(51) Int. Cl. G06F 15/173

(52) U.S. Cl. 709/224

(57) ABSTRACT

A system for providing notification of market information which includes a user computer for specifying a market condition to be monitored, and an electronic source of updated market data is provided. The system also includes a host computer system for receiving and storing the specified market condition to be monitored. Upon receipt of the specified market condition to be monitored, the host computer system generates and transmits confirmation data to the user computer. A monitoring program executable on the host computer system compares the specified market condition and the source of updated market data to determine if the specified market condition is found to exist. If found to exist, the monitoring program generates a signal. A transmitter responsive to the signal generated by the monitoring program transmits notification of the specified market condition.

### FIELD OF THE INVENTION

The invention relates to a system for notifying a portable information device of market data, and more specifically, to a system for providing notification of specified market condition in a timely manner to a portable information device.

### BACKGROUND OF THE INVENTION

Wireless communication systems have proliferated to meet the increasing informational needs of a mobile society. Today, people can access all kinds of information through communication systems utilizing portable information devices (“PIDs”), such as pagers. These prior art communication systems can generally be divided into two categories. The first category of systems employ “dumb” portable information devices to provide information. As the name suggests, “dumb” PIDs simply receive and display whatever information is transmitted to them. Examples of such PIDs are found in U.S. Pat. No. 5,535,428, which discloses portable radio receivers for receiving status of sports events, and U.S. Pat. No. 4,473,824, which discloses a handheld, portable receiver for receiving stock price quotations.

The second category of systems employ “smart” portable information devices to provide information. As the name suggests, “smart” PIDs are user-programmable to selectively receive and display information according to criteria programmed into the PID by a user. Examples of such PIDs are found in U.S. Pat. Nos. 4,845,491, 5,398,021, 5,426,422, 5,543,781 and 5,555,446, which disclose portable selective call receivers which are user-programmable for receiving limited type of data from information monitoring services, such as sports scores and financial/stock market updates.

Although the prior art portable communication systems are generally useful for their limited purposes, they have noticeable disadvantages, especially with respect to “market” information. In this application, the term “market” information or data includes stock market-related information as well as general financial information which would be of interest to any actual or potential investor. Typically, in these systems, a client's request for a specified market condition to be monitored, e.g., “Notify me if and when IBM's share price hits $100”, is conveyed by a telephone call to a monitoring service telephone representative. The monitoring service telephone representative then forwards the request for monitoring by the monitoring service's computer. Note that “client” is defined throughout this application as a person utilizing a portable information device to access market information.

The problem with this manner of conveying the client's request is that the client does not know exactly when his request is received by the monitoring service's computer for monitoring. It may be a matter of minutes or it may take up to several hours for the monitoring service computer to receive the request from the monitoring service telephone representative. Given the speed with which market conditions change, it is very important that the client know that his request is immediately received by the monitoring service's computer for monitoring so that he does not miss a market event of the type he wants to monitor. Therefore, there is a need for a portable communication system which permits a direct telecommunication link between a client or his representative (collectively referred to herein as “user”) and the monitoring service's computer (referred to herein as “host computer”) so that the client's request is immediately received for monitoring. Also, such direct telecommunication link can permit the user to be informed of when the client's request was received by the host computer for monitoring.

Another disadvantage of the prior art portable communication systems is that they are limited in the type of information monitored. As discussed above, these systems provide information of general nature, such as stock price quotes, market averages and volume. However, many investment decisions are predicated upon more specific information, such as share price momentum. Thus, there is a need for a portable communication system which permits monitoring of more specific type of market condition, such as share price momentum (e.g., indicating a price trend in a stock such as each time the share price rises or falls by $1.00).

A further disadvantage of the prior art portable communication systems is that they do not provide an efficient and effective way for the client's financial representative to notify the client of specific market conditions via the PID. Many clients rely upon market information provided by their financial representatives in making investment decisions. Without an effective and efficient means for financial representatives to alert clients of important market events, many investment opportunities are not realized. It is therefore very important to provide a communication system whereby financial representatives can effectively and efficiently notify a client of important market conditions.

Yet another disadvantage is presented by prior art communication systems using “smart” PIDs. Since PIDs, by their very size, provide limited means for input (no keyboard or a very limited keyboard), a client utilizing a “smart” PID has a limited number of preprogrammed information types (e.g., today's Dow Jones Industrial Average) from which he can select the information to be received. Thus, these systems are generally not very useful in making investment decisions due to their limited ability to specify the specific type of market information to be received.

It is readily apparent from the above review of prior art portable communication systems for providing notification of market data that there is a need for a system which will provide a direct telecommunication link between a user and a host computer to specify various types of market conditions to be monitored.

What is desired, therefore, is a system for providing notification of specific market condition to a portable information device utilized by a client, where the system provides direct telecommunication link between a user, especially the client's financial representative, and a host computer so that specific market condition to be monitored is immediately received for monitoring by the host computer, and where the system provides confirmation data to the user upon receipt of the market condition request by the host computer. A system which permits monitoring of share price momentum is also desired.

### SUMMARY OF THE INVENTION

Accordingly, it is an object of the invention to provide a system for providing notification of specific market condition monitored in a timely manner to a portable receiver utilized by a client.

Another object of the invention is to provide a system for providing notification of specific market condition monitored, where the condition requested to be monitored is directly and immediately transmitted to a host computer system by a user.

Yet another object of the invention is to provide a system for providing notification of specific market condition monitored, where the condition requested to be monitored is transmitted to a host computer system by a financial representative through his computer.

Still another object of the invention is to provide a system for providing notification of specific market conditions requested to be monitored, where one such condition monitored is share price momentum.

Another object of the invention is to provide a system for providing notification of specific market conditions requested to be monitored, where there is provided an efficient and effective way of specifying the variety of market conditions to be monitored.

These and other objects of the invention are achieved by a system for providing notification of market information which includes a user computer for specifying a market condition to be monitored, and an electronic source of updated market data. The system also includes a host computer system for receiving and storing the specified market condition to be monitored. Upon receipt of the specified market condition to be monitored, the host computer system generates and transmits confirmation data to the user computer. A monitoring program executable on the host computer system compares the specified market condition and the source of updated market data to determine if the specified market condition is found to exist. If found to exist, the monitoring, program generates a signal. A transmitter responsive to the signal generated by the monitoring program transmits notification of the specified market condition.

The invention and its particular features and advantages will become more apparent from the following detailed description considered with reference to the accompanying drawings.

### BRIEF DESCRIPTION OF THE DRAWINGS

FIG. 1 is a system diagram of a market data notification system in accordance with the invention.

FIG. 2 is a flowchart detailing the comparison conducted by a monitoring program executing on a host computer in the system of FIG. 1 of specific market condition to be monitored with a market information database.

FIG. 3 is a flowchart detailing user input options provided by a program executing on a microprocessor of a user computer in the system of FIG. 1.

FIG. 4 is a flowchart detailing the client settings block of FIG. 3 in the system of FIG. 1.

FIG. 5 is a flowchart detailing the stock symbol settings block of FIG. 3 in the system of FIG. 1.

FIG. 6 is a flowchart detailing the portfolio settings block of FIG. 3 in the system of FIG. 1.

### DETAILED DESCRIPTION OF THE INVENTION

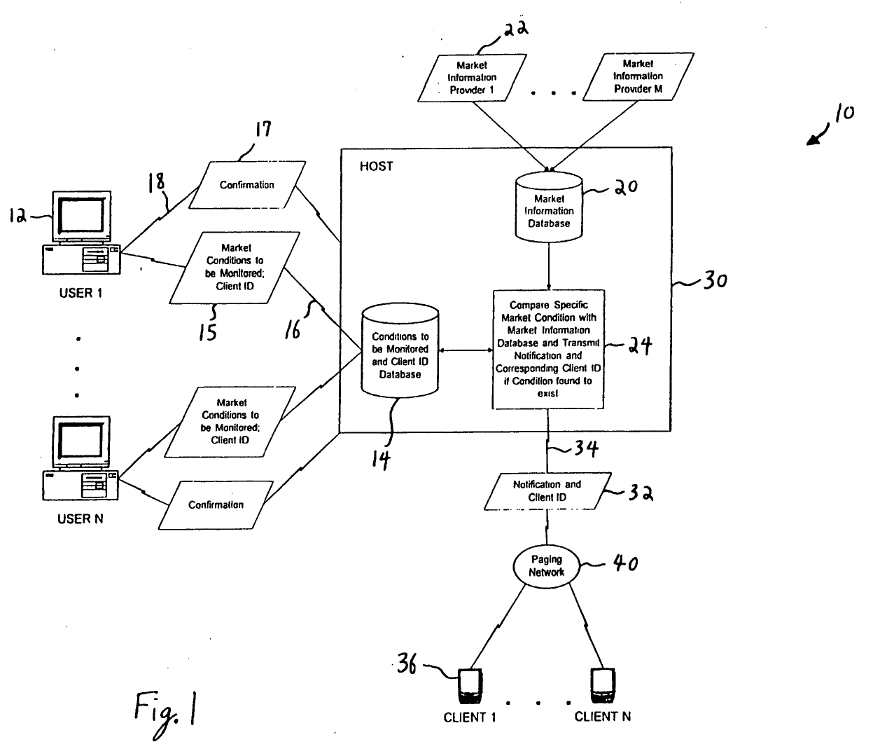

FIG. 1 is a system diagram depicting one embodiment of a market data notification system 10 in accordance with the invention. The market data notification system 10 includes at least one user computer 12 and a host computer system 30. As discussed above in the Background, a “user” is a client or his representative, such as his financial representative. A first telecommunication link 16 provides a connection between the user computer 12 and the host computer system 30. The first telecommunication link 16 may be a public telephone line, a dedicated or other wire link, and/or a wireless link. By “wire” is meant any physical connection, whether by optical fiber, coaxial cable, twisted pair or otherwise, and by “wireless” is meant cellular, microwave, IR, laser or other non-physical connection. The user computer 12 is used for transmitting market conditions to be monitored as well as the identification of the client for whom such market condition is to be monitored 15.

The host computer system 30 includes mass storage capability, such as a database 14, for storing the specific market condition to be monitored and the corresponding client ID 15 received from the user computer 12. Upon receipt of the condition to be monitored and the corresponding client ID 15, the host computer system 30, through its microprocessor (not shown), generates confirmation data 17, such as a simple message that the specified condition 15 was successfully received for immediate monitoring. This confirmation 17 is transmitted to the user computer 12 over a second telecommunication link 18. Note that the confirmation 17 may also be transmitted over the first telecommunication link 16.

The host computer system 30 also includes a second mass storage capability, such as market information database 20. The market information database 20 receives continuously updated market data from at least one market information provider 22, such as Dow Jones & Company. The market information database 20 will thus provide up-to-the-moment stock prices, financial news and other information of interest to any actual or potential investor. As will be described hereinafter, although the embodiment shown in FIG. 1 includes the market information database 20 in the host computer system 30, the market information database 20 may be external to the host computer system 30 or the continuously updated market data from the market information provider 22 may be provided to the host computer system 30 without there being the market information database 20. Where there is no market information database 20, the continuously updated market data from the market information provider 22 may be provided as a stream of data directly accessible to the microprocessor of the host computer system 30.

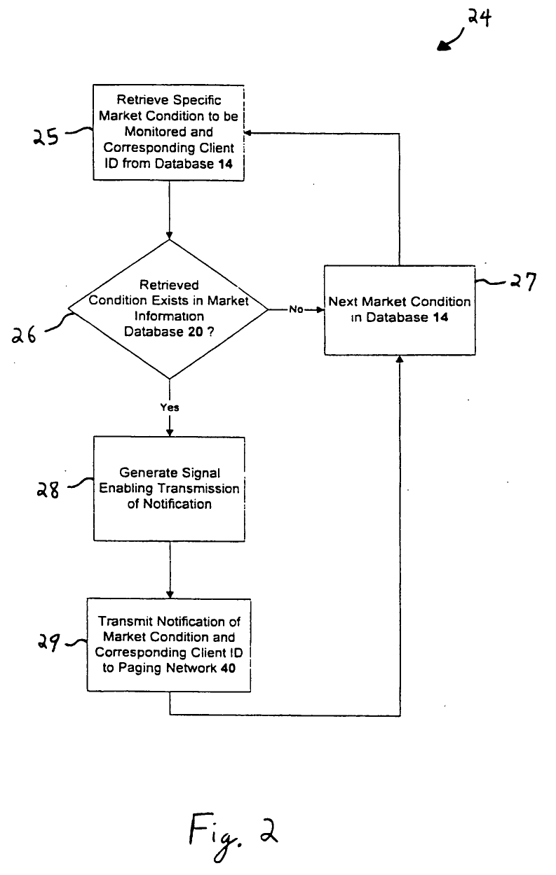

A monitoring program executing on the microprocessor of the host computer system 30 selects specific market conditions from database 14, sequentially or otherwise, and compares the specific market condition with the market information database 20 to determine if the condition specified is found to exist. This process is depicted in greater detail in a flowchart of FIG. 2.

Referring now to FIG. 2, the monitoring program first retrieves a specific market condition to be monitored and the corresponding client ID 15 from the database 14 at block 25. The retrieved condition to be monitored is then compared with the data in the market information database 20 to determine if the condition is found to exist at block 26. Where, as discussed above, the market information database 20 is not utilized to store the continuously updated market data from the market information provider 22, the microprocessor of the host computer system 30 will compare the specific market condition with the stream of data from the provider 22 on the fly to determine if the condition is found to exist. The host computer system 30 may utilize more than one microprocessor for comparing the specific market condition with the stream of data on the fly to facilitate the comparison process.

If the market condition is not found to exist in the market information database 20, the monitoring program prepares to retrieve the next market condition in the database 14 at block 27 and goes back to block 25. If the market condition is found to exist in the market information database 20, the monitoring program causes a signal to be generated for enabling transmission by the host computer system 30 of notification of the market condition at block 28.

Following the signal generation of block 28, transmission of the notification of the market condition and the corresponding client ID 32 to a paging network 40 (see FIG. 1) is performed in block 29. The monitoring program then prepares to retrieve the next market condition in the database 14 at block 27.

The notification of the market condition and the corresponding client ID 32 is transmitted from the host computer system 30 to the paging network 40 via a third telecommunication link 34, as illustrated in FIG. 1. The third telecommunication link 34 may be a wire link or a wireless link; the exact nature of the third telecommunication link 34 is not significant to the invention. The paging network 40 may be any one of the paging networks presently available. Upon reception of the notification of the market condition and the corresponding client ID 32 from the host computer system 30, the paging network 40 forwards the notification of the market condition to the appropriate portable receiver 36 indicated by the client ID.

As would be apparent to those skilled in the art, if there is a plurality of user computers 12, each user computer indicated 12 in FIG. 1 may be a single computer or a local area network (LAN) configuration involving a communications server. The LAN configuration would be desirable, for example, where the users are located at a financial brokerage firm's office building. In this setting, different financial representatives can transmit specific market conditions for one or more clients simultaneously through the network communications server without there being a need for each financial representative to have a direct telecommunication link to the host computer system 30.

One way of transferring the specific market conditions to be monitored as well as client IDs 15 from the user computer 12 to the database 14 is through electronic mail (e-mail) format. The user computer 12 and the host computer system 30 can be configured in a known manner to send and receive e-mail messages.

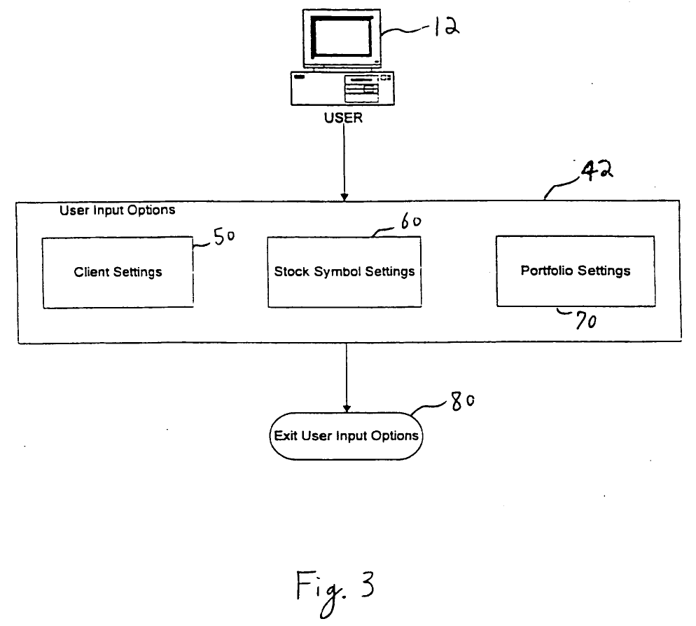

The client information and the specific market conditions to be monitored 15 are specified through the user computer 12 by use of a condition specification program executable by a microprocessor (not shown) of the user computer 12. The various functions of this program are shown in FIGS. 3-6.

FIG. 3 is a flowchart illustrating user-input options 42 provided by the condition specification program of the present invention. These options include client settings option represented by block 50, stock symbol settings option represented by block 60, and portfolio settings option represented by block 70. As shown in FIG. 3, the user of the program may go from one option 50, 60 or 70 to another option 50, 60 or 70 at any time. Finally, when the user has finished specifying the different desired parameters, he can exit the program at block 80.

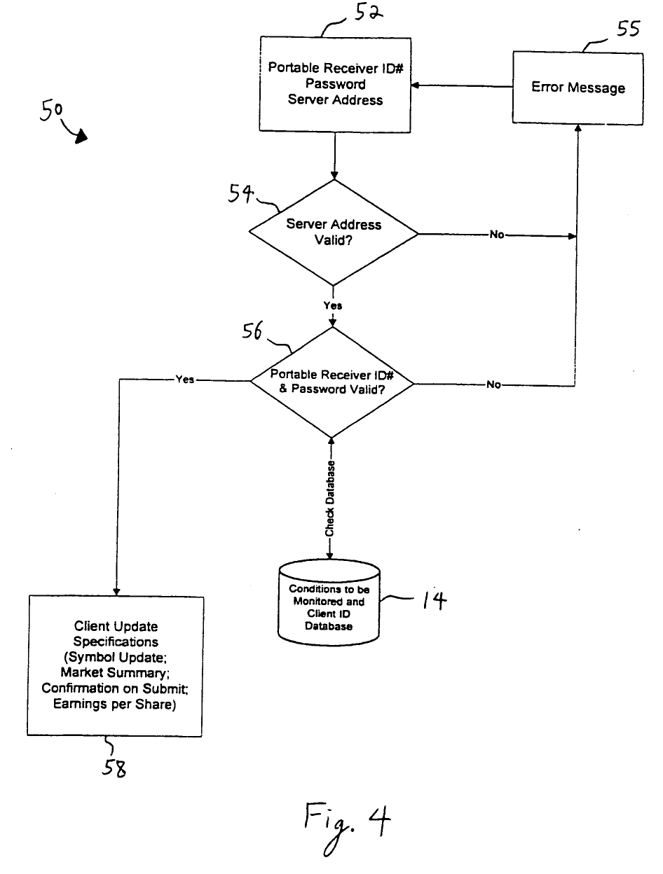

Referring now to FIG. 4, there are shown the different procedures comprising the client settings option represented by block 50 of FIG. 3. The user enters or modifies the identification number for the portable receiver 36 of the client, an associated password, and the network address of the communications server (block 52). In step 54, a check is made to determine if the server address specified is valid. If not, an appropriate error message is displayed (block 55) and the program returns to block 52. Otherwise, the program proceeds to step 56. Where the communications server is not used, the server address will not need to be specified and step 54 will be bypassed.

In step 56, the program checks to determine if the identification number for the portable receiver 36 and the associated password are valid. This determination is made by checking the data entered in step 52 with the data extant in the conditions and client ID database 14. If the data specified in step 52 is not found in the database 14, the program provides an appropriate error message (step 55) and returns to block 52. If the data specified in step 52 is found in the database 14, then the program proceeds to block 58.

Block 58 provides for user entry or modification of client specifications. As shown, these include: Symbol Update, which specifies how frequently (e.g., every hour) stock symbols selected for monitoring should be provided to the portable receiver 36; Market Summary, which provides market information (e.g., Dow Jones Industrial Average) at a predetermined time interval; Confirmation on Submit, which allows the user to select whether he wishes to receive confirmation 17 that the host computer system 30 has received the conditions he specified for monitoring (default is to receive the confirmation 17); and Earnings per Share, which provides earnings per share of each company stock symbol being monitored at a predetermined time interval. It must be noted that the client specifications of block 58 are only illustrative, and are not limiting in any way.

As discussed in the Background of the Invention, the confirmation 17 is significant because it lets the user know exactly when his request is received for monitoring by the host computer system 30. By knowing when his request is received for monitoring, the user need not be concerned as to when and if the market event of the type he wants to monitor was received for monitoring by the host computer system 30. Furthermore, the lack of the confirmation 17 will inform the user that he should retransmit the market condition to be monitored 15 to the host computer system 30 since the previous transmission of the market condition to be monitored 15 may not have been properly received by the host computer system 30.

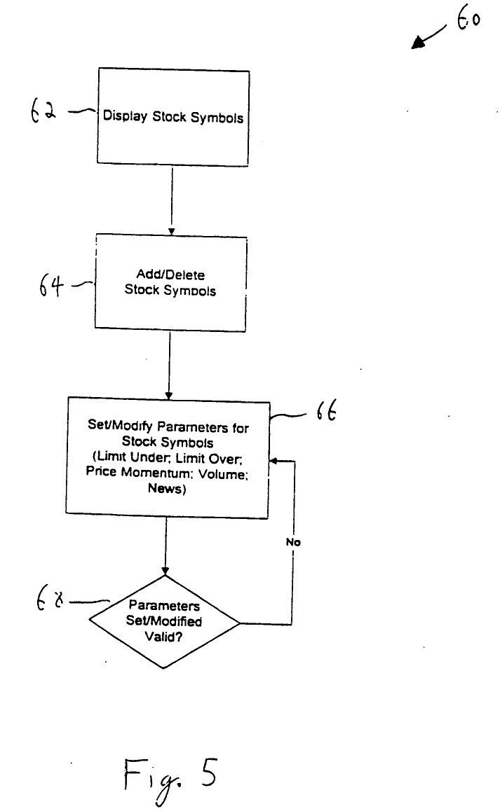

Referring to FIG. 5, there are shown the different procedures comprising the stock symbol settings option represented by block 60 of FIG. 3. The stock symbols selected for monitoring, if any, are displayed on a display screen of the user computer 12 (block 62). The user may then add or delete stock symbols to be monitored at step 64.

Block 66 provides for user entry or modification of parameters for each stock symbol to be monitored. These include, without limitation, the following: Limit Under, which causes notification to be sent if the share price falls below the specified price; Limit Over, which causes notification to be sent if the share price exceeds the specified price; Price Momentum, which causes notification to be sent each time the price increases or decreases by a specified amount (for example, $1); Volume, which causes notification to be sent if the volume of trades exceeds the specified volume; and News, which causes notification to be sent if a news story relating to the symbol is introduced by a specified source (for example, Dow Jones & Company). In step 68, the program checks to determine if the parameters specified by the user are valid. If not (e.g., Limit Over value is less than Limit Under value), then the program returns to block 66.

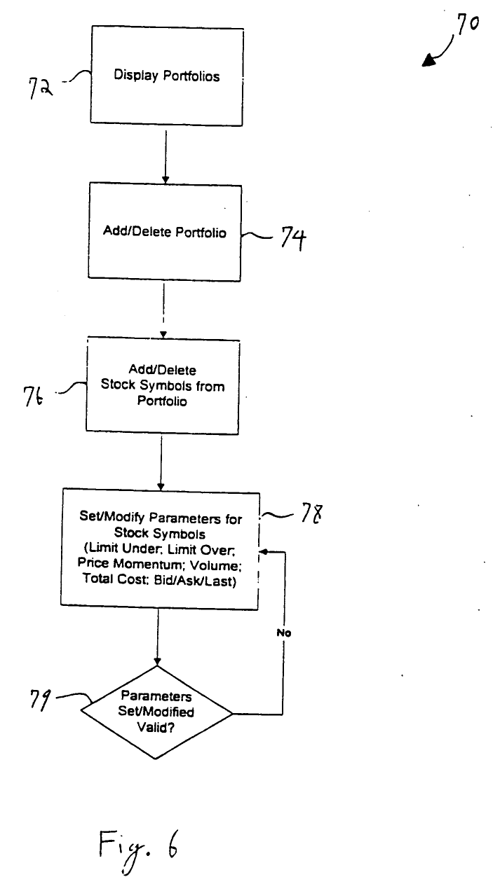

In FIG. 6, there are shown the different procedures comprising the portfolio settings option represented by block 70 of FIG. 3. The portfolios selected for monitoring, if any, are displayed on the display screen of the user computer 12 (block 72). The user may then add or delete portfolios to be monitored at step 74. For each portfolio to be monitored, the user may add or delete stock symbols contained therein (block 76).

Block 78, much like block 66 of FIG. 5, provides for user entry or modification of parameters for each stock symbol to be monitored in each portfolio to be monitored. These parameters include, without limitation, the following: Limit Under; Limit Over; Price Momentum; Volume; Total Cost, which is the total value of the shares owned by the client; and Bid/Ask/Last, which is the bid price, the asking price and the last price, respectively, for one share of the stock. In step 79, the program checks to determine if the parameters specified by the user are valid. If not, then the program returns to block 78.

Although the invention has been described with reference to particular arrangements of parts, features and the like, these are not intended to exhaust all possible arrangements or features, and indeed many other modifications and variations will be ascertainable to those of skill in the art.

What is claimed is:

1. A system for providing notification of market information, which comprises:
a user computer for specifying a market condition to be monitored and a corresponding client ID via a first telecommunication link;
an electronic source of updated market data;
a host computer system for receiving and storing a plurality of the market conditions specified for monitoring and the corresponding client IDs;
confirmation data generated and transmitted by said host computer system via a second telecommunication link upon receipt of the specified market condition to be monitored and the corresponding client ID, said confirmation data indicating that the specified market condition has been received by said host computer and will be monitored;
a monitoring program executable on said host computer system for comparing each of the specified market conditions stored on said host computer system and said source of updated market data to determine if a specified market condition is found in said source of updated market data, said monitoring program generating a signal if a specified market condition is found to exist, the signal indicative of the found specified market condition and the corresponding client ID stored on said host computer system; and
a transmitter responsive to said signal for transmitting notification of the specified market condition via a third telecommunication link to a paging network, said paging network, upon receipt of the notification of the specified market condition and the corresponding client ID, forwarding the notification of the specified market condition to an appropriate portable receiver indicated by the client ID.

2. The system of claim 1, further comprising a program executable on said user computer for providing share price momentum as a market condition to be monitored.

3. The system of claim 1, wherein said user computer specifies the market condition to be monitored in electronic mail format.

4. The system of claim 1, wherein said user computer is a financial representative's computer.

5. A system for providing notification of market information receivable by a client, which comprises:
a user computer for specifying a market condition to be monitored and a corresponding client ID via a first telecommunication link;
an electronic source of updated market data;
a host computer system including a database for receiving and storing a plurality of the market conditions specified for monitoring and the corresponding client IDs;
confirmation data generated and transmitted by said host computer system via a second telecommunication link upon receipt of the specified market condition and corresponding client ID by said database, said confirmation data indicating that the specified market condition has been received by said host computer and will be monitored;
a monitoring program executable on said host computer system for comparing each of the specified market conditions stored on the database and said source of updated market data to determine if a specified market condition is found in said source of updated market data, said monitoring program generating a signal if a specified market condition is found to exist, the signal indicative of the found specified condition and the corresponding client ID stored on the database; and
a transmitter responsive to said signal for transmitting notification of the specified market condition and the corresponding client ID via a third telecommunication link to a paging network, said paging network, upon receipt of the notification of the specified market condition and the corresponding client ID, forwarding the notification of the specified market condition to an appropriate portable receiver indicated by the client ID.

6. The system of claim 5, further comprising a program executable on said user computer for providing share price momentum as a market condition to be monitored.

7. The system of claim 5, wherein said user computer specifies the market condition to be monitored and the corresponding client ID in electronic mail format.

8. The system of claim 5, wherein said user computer includes a communications server.

9. A method for providing notification of market information, which comprises the steps of:
providing a software program to a user for specifying a market condition to be monitored and a corresponding client ID via a first telecommunication link;
receiving and storing a plurality of the specified market conditions to be monitored and the corresponding client IDs in a host computer system;
generating and transmitting confirmation data via a second telecommunication link for receipt by the user when the specified market condition to be monitored and the corresponding client ID is received by said host computer system, the the confirmation data indicating that the specified market condition has been received by the host computer and will be monitored;
comparing each of the specified market conditions stored on the host computer system with a source of updated market data to determine if a specified market condition is found to exist;
generating a signal if the specified market condition is found to exist indicative of the found specified market condition and the corresponding client ID on the host computer system;
transmitting notification of the specified market condition to a paging network via a third telecommunication link in response to said signal; and
forwarding, upon receipt of the notification of the specified market condition and the corresponding client ID, with the paging network, the notification of the specified market condition to an appropriate portable receiver indicated by the client ID.

10. The method of claim 9, further comprising the step of specifying a client ID corresponding to the market condition specified to be monitored.

11. The method of claim 9, wherein the market condition specified to be monitored includes share price momentum.
